(19) United States
(12) Patent Application Publication
(10) Pub. No.: US 2008/0259556 A1
(43) Pub. Date: Oct. 23, 2008

(54) Modular graphics expansion system

(76) Inventors: Mark S. Tracy, Tomball, TX (US); Paul J. Doczy, Cypress, TX (US); Jonathan R. Harris, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/788,460

(22) Filed: Apr. 20, 2007

(51) Int. Cl. G06F 1/20

(52) U.S. Cl. 361/687

(57) ABSTRACT

A modular graphics expansion system comprises a modular graphics expansion base communicatively couplable to a portable electronic device to enable the electronic device to transition from a standard graphics mode of operation to an enhanced graphics mode of operation.

### BACKGROUND

Portable electronic devices, such as laptop and notebook computers, comprise graphic systems for generating and displaying graphical and video content on a display screen. However, the graphic systems incorporated into portable electronic devices are generally configured to operate at a lower performance level than graphic systems typically incorporated into desktop computer devices because of limited space to receive the components associated with typical desktop graphic systems, the inability to effectively dissipate the levels of thermal energy generated by such components, the increased weight and costs of such components, and the drain on battery resources of the portable electronic device.

### BRIEF DESCRIPTION OF THE DRAWINGS

Various embodiments and the advantages thereof are best understood by referring to the drawings, like numerals being used for like and corresponding parts of the drawing, in which:

FIG. 1 is a diagram of a perspective view of a portable electronic device employing an embodiment of a modular graphics expansion system to advantage.

### DETAILED DESCRIPTION OF THE DRAWINGS

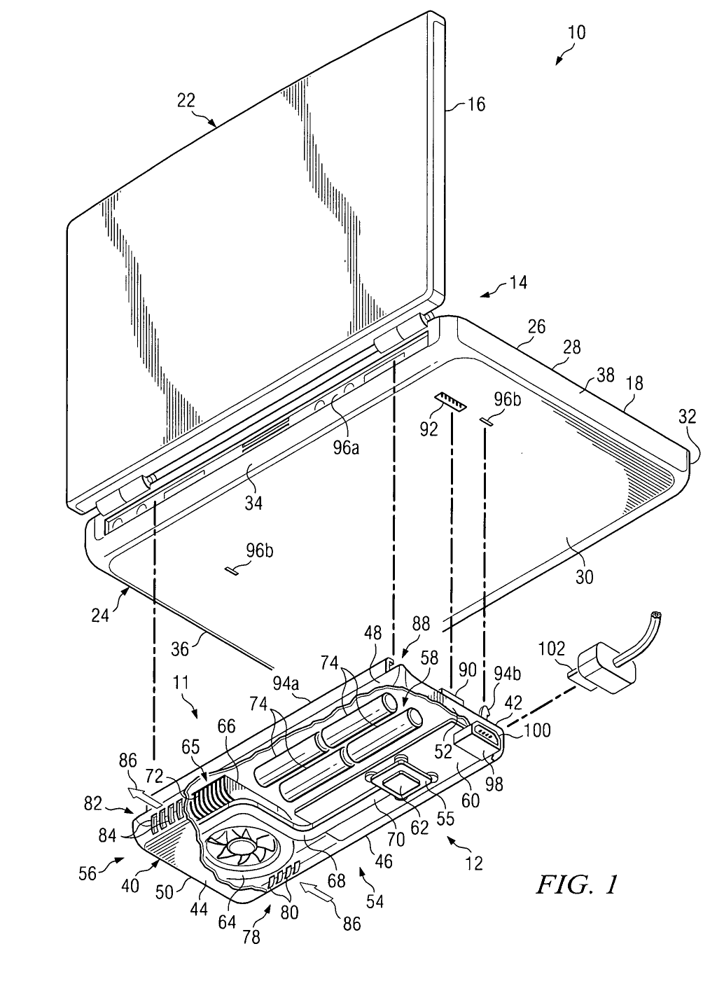

FIG. 1 is a diagram of a perspective view of a portable electronic device 10 employing an embodiment of a modular graphics expansion system 11 to advantage. In the embodiment illustrated in FIG. 1, electronic device 10 comprises a laptop or notebook computer 14; however, it should be understood that electronic device 10 may comprise any type of portable computing device such as, but not limited to, a tablet personal computer, a personal digital assistant, a gaming device, or any other type of portable computing device. In the embodiment illustrated in FIG. 1, electronic device 10 comprises a display member 16 rotatably coupled to a base member 18. Display member 16 and base member 18 each comprise a housing 22 and 24, respectively, formed having a number of walls. For example, housing 24 comprises a top wall 26 defining a working surface 28, a bottom wall 30, a front wall 32, a rear wall 34 and a pair of sidewalls 36 and 38.

In the embodiment illustrated in FIG. 1, modular graphics expansion system 11 comprises a modular expansion base 12 removably coupleable to electronic device 10 to configure electronic device 10 between a standard graphics mode of operation and an enhanced graphics mode of operation. For purposes herein, the standard graphics mode comprises a mode of operation of electronic device 10 where electronic device 10 utilizes an on-board graphics system (e.g., video cards, controllers, etc., disposed solely within electronic device 10) to generate/provide graphical and/or video output. The enhanced graphics mode comprises a mode of operation of electronic device 10 where electronic device 10 utilizes a graphics system (e.g., video cards, controllers, etc.) disposed within expansion base 12 to provide graphical and/or video capabilities in addition and/or enhancement to the graphical and/or video capabilities of the on-board graphics system disposed within electronic device 10. Accordingly, when electronic device 10 is operating in the enhanced graphics mode, electronic device 10 is operable at higher graphics performance levels (e.g., output images, including complex output images, are generated and displayed at faster rates) than can be obtained by the on-board graphics system. According to some embodiments, by utilizing expansion base 12, electronic device 10 is operable at higher performance levels without increasing the size of electronic device 10 (e.g., increasing the size of housings 22 and/or 24 to store graphic components and associated cooling systems) or increasing the level of thermal energy needed to be dissipated by device 10 (e.g., power from expansion base 12).

In some embodiments, electronic device 10 is automatically configured to operate in the enhanced graphics mode in response to expansion base 12 being coupled to electronic device 10. Similarly, in some embodiments electronic device 10 is automatically configured revert to the standard graphics mode in response to detachment of expansion base 12 from electronic device 10. According to some embodiments, electronic device 10 may have a manual override function to enable a user to configure electronic device 10 in the standard graphics mode even when expansion base 12 is coupled to electronic device 10, such as when it is desirable to limit or reduce power consumption by electronic device 10 (e.g., power from expansion base 12). Further, it should be understood that electronic device 10 may be manually switchable between the standard graphics and enhanced graphics modes while expansion base 12 is coupled to electronic device 10.

In the embodiment illustrated in FIG. 1, modular expansion base 12 comprises a housing 40 having a top surface 42, a bottom surface 44, a front surface 46, a rear surface 48, and a pair of side surfaces 50 and 52. In the embodiment illustrated in FIG. 1, expansion base 12 comprises a graphics system 54, a cooling system 56 and a power supply 58. In FIG. 1, graphics system 54 comprises one or more components, chipsets or other elements disposed on a printed circuit board or otherwise for generating and displaying graphical and/or video content on a display screen of display member 16. In the embodiment illustrated in FIG. 1, graphics system 54 comprises a video card 60 having a graphic controller 62 for generating and displaying graphical and/or video content. It should be understood that graphics system 54 may be otherwise configured for generating and displaying graphical content.

In the embodiment illustrated in FIG. 1, cooling system 56 comprises an air flow device or cooling fan 64, a heat dissipating element 65 configured as a heat exchanger 66, and a heat transport element 68 thermally coupling graphics system 54 to heat exchanger 66. Graphics system 54 is coupled to heat transport element 68 via a clamping mechanism 55. Heat transport element 68 may comprise any type of thermally conductive element capable of transferring heat from graphics system 54 to heat exchanger 66. For example, in some embodiments, heat transport element 66 comprises a heat pipe 70 filed with a vaporizable liquid to increase heat transfer performance. In the embodiment illustrated in FIG. 1, heat exchanger 66 comprises a plurality of fins 72 to facilitate thermal energy dissipation from heat exchanger 66. In operation, ambient cooling air is directed from cooling fan 64 through heat exchanger 66 to dissipate thermal energy generated by graphics system 54 and/or to dissipate thermal energy otherwise generated within housing 40.

In the embodiment illustrated in FIG. 1, power supply 58 comprises one or more battery cells 74 for supplying power to expansion base 12 and/or electronic device 10; however, it should be understood that expansion base 12 may be configured without battery cell(s) 74. In some embodiments, battery cell(s) 74 comprises rechargeable battery cell(s) configured to be recharged by an external power supply coupleable to electronic device 10 and/or coupleable to expansion base 12 (e.g., recharged by power received through electronic device 10 or received directly by expansion base 12 by another device/adapter). It should be understood that expansion base may be otherwise configured (e.g., expansion base 12 may be configured to receive and/or otherwise accept alkaline batteries that may be removed/replaced by a user). Thus, in some embodiments, expansion base 12 is configured as a graphics battery pack by providing both enhanced graphics capability and a battery power supply to electronic device 10.

In operation, cooling fan 64 is configured to draw an airflow into housing 40 through an inlet 78 having openings 80 and located on surface 46. In FIG. 1, housing 40 comprises at least one airflow outlet 82 having a plurality of openings 84 disposed on surface 48 and adjacent to heat exchanger 66. In operation, cooling fan 64 generates an airflow into housing 40 from inlet 78 and following airflow path 86 through heat exchanger 66 to exhaust warmed cooling air through outlet 82. As airflow travels along airflow path 86, thermal energy generated by graphics system 54 and/or any other heat generating device disposed within housing 40 (e.g., battery cells 74) is dissipated through outlet 82. It should be understood that a greater number of inlets 78 and/or outlets 82 may be disposed on housing 40 and/or any other surface of housing 40 (e.g., surface 42, 44, 46, 48, 50 and/or 52). Further, it should be understood that in some embodiments, cooling fan 64 may be used to dissipate thermal energy from electronic device 10 (e.g., from housing 24 by drawing an airflow therefrom or therethrough via a vent located on bottom wall 30 of housing 24 that is disposed in alignment with cooling fan 64 when expansion base 12 is coupled to electronic device 10).

In the embodiment illustrated in FIG. 1, expansion base 12 is removeably couplable to electronic device 10 by a locking mechanism 88. In FIG. 1, expansion base 12 comprises a connector 90 alignable with and readily insertible within a corresponding connector 92 disposed on base member 18, thereby facilitating communicative engagement between electronic device 10 and expansion base 12. In the embodiment illustrated in FIG. 1, locking mechanism 88 comprises a hook 94a insertible into a recess 96a disposed on rear wall 34, and a plurality of hooks 94b insertible into a plurality of correspondingly positioned openings 96b disposed on bottom surface 30 of base member 18 to securely fasten expansion base 12 to electronic device 10. However, it should be understood that other devices or methods may be used to removeably secure expansion base 12 to base member 18 using other locations and/or surfaces of base member 18 (e.g., surfaces 26, 32, 34, 36 and/or 38).

According to some embodiments, expansion base 12 may comprise an input/output (I/O) port 98 to facilitate communication with external devices. For example, I/O port 98 may comprise a video connector 100 configured to receive a corresponding connector 102 from a display device or other type of external presentation device. It should be understood that I/O port 98 may be otherwise configured (e.g., a USB connector port). Further, it should be understood that additional I/O ports 98 and/or connectors 100 may be provided on expansion base 12.

Thus, embodiments of expansion base 12 may be manufactured to provide an enhanced graphic mode of operation for an electronic device 10 to which expansion base 12 is attached. In addition, embodiments provide a cooling system 56 to dissipate thermal energy generated by expansion base 12. Furthermore, embodiments of expansion base 12 may be manufactured to provide an additional source of power to power electronic device 10 and/or itself Thus, embodiments of modular expansion base 12 provide a self-contained graphics system 54 for enhancing the graphics capabilities of a particular electronic device 10 to which expansion base 12 is attached.

What is claimed is:

1. A modular graphics expansion system, comprising:
a modular graphics expansion base communicatively couplable to a portable electronic device to enable the electronic device to transition from a standard graphics mode of operation to an enhanced graphics mode of operation.

2. The system of claim 1, wherein the modular graphics expansion base is removably coupleable to a base member of the electronic device.

3. The system of claim 1, wherein the modular graphics expansion base comprises a cooling fan to generate an airflow.

4. The system of claim 1, wherein the electronic device is configured to operate in the enhanced graphics mode in response to engagement of the expansion base with the electronic device.

5. The system of claim 1, wherein the electronic device is configured to automatically transition from the enhanced graphics mode to the standard graphics mode in response to disengagement of the modular graphics expansion base from the electronic device.

6. The system of claim 1, wherein the modular graphics expansion base comprises at least one battery cell.

7. The system of claim 1, wherein the modular graphics expansion base comprises at least one connector member for communicative engagement with an external video device.

8. The system of claim 1, wherein the modular graphics expansion base comprises a heat exchanger.

9. A modular graphics expansion system, comprising:
a modular graphics expansion base removeably coupleable to a portable electronic device to enable the electronic device to transition from a standard graphics mode of operation to an enhanced graphics mode of operation.

10. The system of claim 9, wherein the modular graphics expansion base is removably coupleable to a base member of the electronic device.

11. The system of claim 9, wherein the modular graphics expansion base comprises a cooling fan.

12. The system of claim 9, wherein the modular graphics expansion base comprises a graphics system to enable the electronic device to operate in the enhanced graphics mode.

13. The system of claim 9, wherein the modular graphics expansion base comprises at least one battery cell.

14. The system of claim 9, wherein the modular graphics expansion base comprises at least one input/output port for communicating graphics data to an external video device.

15. The system of claim 9, wherein the modular graphics expansion base comprises a heat dissipation element.

16. A method of manufacturing a modular graphics expansion base, comprising:
providing a housing removeably coupleable to a portable electronic device; and
disposing a graphics system in the housing to enable the electronic device to transition from a standard graphics mode of operation to an enhanced graphics mode of operation.

17. The method of claim 16, further comprising providing a cooling fan within the housing to generate an airflow.

18. The method of claim 16, further comprising providing at least one battery cell within the housing.

19. The method of claim 16, further comprising providing a connector member on the housing for communicating graphics data to an external video device.

20. The method of claim 16, further comprising providing a heat dissipation element within the housing.
